(19) United States
(12) Patent Application Publication
(10) Pub. No.: US 2026/0261845 A1
(43) Pub. Date: Sep. 3, 2026

(54) OBFUSCATION OF IES IN MANAGEMENT FRAMES USING CONTAINER IES WITH ENCRYPTED INFORMATION SECTION

(71) Applicant: CANON KABUSHIKI KAISHA, Tokyo (JP)

(72) Inventors: Stéphane BARON, LE RHEU (FR); Patrice NEZOU, LIFFRE (FR); Julien SEVIN, SAINT AUBIN DU CORMIER (FR)

(21) Appl. No.: 18/881,670

(22) PCT Filed: Jul. 6, 2023
(86) PCT No.: PCT/EP2023/068654

§ 371 Date: Jan. 6, 2025

(30) Foreign Application Priority Data
Jul. 7, 2022 (GB) 2209959.2

(51) Int. Cl. H04W 12/02; H04W 12/03

(52) U.S. Cl. CPC H04W 12/02; H04W 12/03

(57) ABSTRACT

The invention improves user privacy in wireless networks by making fingerprinting of management frames more difficult. It is achieved by obfuscating the IEs that populate a management frame. Some IEs to be included in the management frame are grouped into sets; each set of one or more IEs is encrypted into an encrypted portion; each encrypted portion is embedded within the information part of a new IE, acting as a container. One or more of such Container IEs are then embedded in the frame body of the management frame under construction. The management frame can then be transmitted. By changing obfuscating parameters used to build the Container IEs, when the station changes its own MAC address based on a RCM procedure, the same frame, such as a beacon frame, can have a very different fingerprint after the MAC address change. Fingerprint-based correlation between frames is therefore made more difficult.

### FIELD OF THE INVENTION

The present invention relates to wireless communications and more specifically to user privacy during wireless communications.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section. Furthermore, all embodiments are not necessarily intended to solve all or even any of the problems brought forward in this section.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks. The 802.11 family of standards adopted by the Institute of Electrical and Electronics Engineers (IEEE) provides a great number of mechanisms for wireless communications between stations.

Today, the evolution of wireless systems has brought privacy concerns at the forefront, driven by user demand and requirements of the General Data Protection Regulation (GDPR). The global wireless industry is faced with the growing need to protect users' personally identifiable information from increasingly sophisticated user tracking and user profiling activities, while continuing to improve wireless services and the user experience.

The Personally Identifiable Information (PII) corresponds to any data that identifies an individual or from which identity or contact information of an individual can be derived. For instance, in the context of 802.11, PII may be the use of unique identifiers (such as MAC addresses or SSIDs) that can be directly connected to a single device or small group of devices (and therefore owner(s) of such a device(s)). Below, the PII are referred to as privacy parameters or PE (Privacy Enhancements) parameters.

The Media Access Control (MAC) address of a user device is often used to track the user. Indeed, the access points (APs) of wireless networks can monitor the locations of mobile devices (tablets, laptops, mobile phones, . . . ) of a user without his consent, by means of their MAC addresses. This is for example because, as the user moves, his mobile phone sends requests to determine if there are any access points nearby, these requests conveying the MAC address of the mobile phone. It is then possible to track a user by reconstructing his trajectory from access points to which his phone has sent his MAC address.

The IEEE 802.11 working group has then proposed a procedure to limit the risk of a user being traced, which consists in dynamically modifying the MAC address of the user device. This mechanism, called Randomized and Changing MAC (RCM) procedure, has been originally introduced as a privacy enhancing feature in the 802.11aq Pre-Association Service Discovery Task Group and finally included in the standard IEEE Std 802.11-2020. It comprises periodical change of the MAC address of a non-AP station (i.e. a station which is not an access point) to a random value, while the non-AP station (STA) is not associated with a network (or, equivalently, to an access point).

Enhanced RCM procedures now propose to extend this approach to other PII than the sole MAC address, applicable to AP stations as well as already associated non-AP stations.

Although there is a trend to encrypt the frames in wireless networks to provide confidentiality of their content (usually applicable to data frames), there is a number of frames, in particular management frames, that cannot be encrypted as a whole because of backwards compatibility with older stations in evolving standards, e.g. the IEEE802.11 standards family (a, b, e, g, n, ac, ah, ax, be) or the 3GPP standards family (GSM, 3G/UMTS, 4G/LTE, 5G/NR).

Such management frames include one or more so-called information elements, or IEs or elementary IEs, that structure the provision of cell-related or station-related information. An IE is basically a structured field made of a type indicator or tag, a length indicator and a value or information. An elementary IE is an IE where the information portion does not comprise another IE. As an example, an IE in the IEEE802.11 standards family is made of an Element ID field optionally supplemented with an Element ID Extension field (acting together as the type indicator), a Length field (acting as the length indicator) and an Information field conveying the content of the IE. “information”, “value”, “body”, “payload” are synonymous to designate the content of the Information field of the IE.

Depending on the standard version of the user device, some or other IEs are known (and used) or not. To allow the user devices to select the IEs it needs from the body of the management frame, there is a need to keep the IE's type indicator in clear or plain text (i.e. not encrypted).

The IEs are therefore openly accessible to an observer, hence giving rise to privacy issues, despite the RCM-based change of the MAC address of the user device as explained above.

Indeed, thanks to the IEs provided in the management frame, an observer is able to correlate the same signature (or fingerprint) to successive management frames sent by the same station, despite they specify different MAC addresses. A mere analysis (known as fingerprinting technic) of a set of information elements is therefore enough, which is made even more simple with the arising of Artificial Intelligence technics.

Therefore, there is a need to provide enhanced protection of the privacy of user devices in wireless networks.

### SUMMARY OF THE INVENTION

In this context, the invention provides a communication method in a wireless network, comprising, at a station:
encrypting a set of one or more information elements, IEs, to be included in a management frame to be transmitted, into an encrypted portion,
embedding the encrypted portion within an information field of a container IE,
embedding the resulting container IE in a body of the management frame, and
transmitting the resulting management frame over the wireless network.

In the present document, a “station” means any wireless station in a wireless network. In particular this includes IEEE802.11 stations, which may be standalone IEEE802.11 stations or affiliated stations or multi-link devices (MLD) within the recent 802.11be D2.0 standard. A MLD is a standalone device having plural affiliated stations operating on separate respective wireless mediums of the network.

The Container IE acts as a container to receive one or more IEs. It is therefore not an elementary IE contrary to the IEs it embeds. The Container IE allows the station to obfuscate the contained elementary IEs, hence to reduce risks that fingerprinting correlates the management frame with another management frame transmitted by the same station. Indeed, the Container IE is an efficient tool to easily vary the content of the management frame, while keeping the original IEs unmodified. As exemplified below, various options to vary a Container IE over time (i.e. between two frames sent by the same station) are available, such as changing the encryption scheme used and/or varying an order of the IEs within the Container IE and/or varying an obfuscating padding in the Container IE before encryption.

By having the encrypted portion in the information field of the container IE only, the type indication of the container IE can be kept in clear text to allow the stations (whatever the version of the standard they implement) to select it or not.

Optional features of the invention are defined below with reference to a method, while they can be transposed into device features. The various embodiments below can be combined, unless obvious incompatibility.

In some embodiments, the method further comprises adding a padding portion to the set of one or more IEs before encrypting them together into the encrypted portion. The padding portion can advantageously be modified over time, hence acting as an obfuscating tool. Fingerprinting on the management frame is therefore made more difficult.

In specific embodiments, a length and/or a binary content of the padding portion is variable between container IEs and/or over time. A change over time may for example be made upon RCM-based changing the MAC address of the station or any other privacy parameter thereof. As a result, correlation between distinct management frames is made more difficult.

In other specific embodiments, a length and/or a binary content of the padding portion is determined randomly per container IE. Randomization makes a correlation or fingerprinting between management frames even more difficult.

In other embodiments, the method further comprises calculating a hash of the encrypted portion and including the hash in a subfield preceding the encrypted portion within the information field of the container IE. Of course, the hash may be alternatively provided in other locations within the management frame or within the container IE. This feature advantageously allows a receiving or addressee station to skip the Container IE when a previous management frame already provided it. This reduces complexity at the receiving or addressee station or stations.

In other embodiments, the method further comprises signaling an encryption scheme of the encrypted portion in a subfield preceding the encrypted portion within the information field of the container IE. This allows the receiving or addressee station or stations to correctly decode the content of the Container IE. Furthermore, different encryption schemes may be used for different Container IEs.

In specific embodiments, the encryption scheme is signaled in a non-encrypted IE preceding the encrypted portion within the information field of the container IE. Alternatively, this may be a mere field, starting the information field of the container IE. An easy access to the encryption scheme to be used is therefore obtained by receiving or addressee station or stations.

In other embodiments, the method further comprises signaling an encryption scheme of the encrypted portion in a non-encrypted IE preceding the container IE within the body of the management frame. This configuration reduce signaling (hence overhead) as the same encryption scheme (e.g. encryption algorithm and cryptographic key or keys) can be used for plural Container IEs.

Alternatively to the above signaling, the method may further comprise determining an encryption scheme for encrypting the set, based on a predefined table matching encryption schemes with respective IEs. In that case and as described below, IEs may be grouped by encryption scheme, in such a way a set of such IEs is encrypted using the common encryption scheme. An exemplary encryption scheme may provide no encryption, while other encryption schemes may differ one from the other by different encryption keys and/or different encryption algorithms.

The predefined table saves signaling costs in the management frame. Such a predefined table may ultimately be added to the IEEE802.11 standard, so that each compliant station knows it.

In some embodiments, plural container IEs containing encrypted portions corresponding to respective encrypted sets of one or more IEs are embedded in the body of the management frame. This allows for example to obfuscate multiple IEs although they cannot be encrypted using the same encryption scheme.

In specific embodiments, all the IEs included in the management frame that is transmitted are embedded in one or more container IEs within the body of the management frame. With this configuration, all the elementary IEs to be included in the frame are obfuscated.

In some embodiments, one IE included in the management frame that is transmitted is an isolated IE directly embedded within the body of the management frame, with an encrypted information field and non-encrypted type and length fields of the isolated IE. In this configuration, the IE is not included in a Container IE, but only its information field is encrypted so that its type indication is kept in clear text. This contributes to make fingerprinting more difficult, in particular when the encryption evolves over time (algorithm or key for example).

In specific embodiments, an encryption scheme of the encrypted information field is signaled in a separate non-encrypted IE preceding the isolated IE within the body of the management frame. This allows the receiving or addressee station or stations to correctly decrypt the isolated IE. By using the separate non-encrypted IE, the same encryption scheme may be used for plural isolated IEs that follows the separate non-encrypted IE, hence saving signaling costs. Where a single separate non-encrypted IE indicating an encryption scheme is provided, the latter may apply to each isolated IE in the frame.

In embodiments, some elementary IEs not included in container IEs may also be kept not-encrypted as in the known technics.

In some embodiments, the method further comprises determining, for each IE to be included in the management frame, whether to aggregate the IE with other IEs in a container IE before encryption or to encrypt the IE as an isolated IE (i.e. independently of the other 802.11 IEs). This contributes to appropriate backwards compatibility as well as appropriate functioning of the wireless networks, where some elementary IEs must remain accessible to any station, e.g. to join the cell or Basic Service Set, BSS.

In specific embodiments, the determining is based on whether the IE is used by a station addressee of the management frame to associate with a station transmitting the management frame.

In other specific embodiments, the determining is based on whether the IE is mandatory or optional according to the IEEE802.11 standards family, for example according to the 802.11be D2.0 standard.

In yet other specific embodiments, the determining is based on a type of the management frame, and optionally on a type of the IE. By “type” it is meant the type as defined in a dedicated Type (or the like, such as Element ID) field of the concerned frame or IE, according to the standards considered.

In some embodiments, the method comprises, in case it is determined to aggregate the IE, determining an encryption scheme for the IE and selecting a container IE associated with the same encryption scheme as the determined encryption scheme. This allows grouping the IEs having the same encryption scheme within the same Container IE, in order to have an efficient encryption thereof.

In specific embodiments, the method comprises, in case no container IE associated with the determined encryption scheme exists, creating a new container IE associated with the determined encryption scheme and adding the IE to the new container IE.

In some embodiments, a single container IE associated with a given encryption scheme is embedded (or provided) within the body of the management frame, to aggregate all the IEs of the management frame that are associated with the encryption scheme. This advantageously reduces the overhead to signal and carry the IEs, hence only requires a single call to a decrypting and parsing function to obtain all the IEs.

In other embodiments, two or more container IEs associated with the same encryption scheme are embedded within the body of the management frame, to include all the IEs that are associated with the encryption scheme. This advantageously provides the AP with more options to manage the various IEs to be embedded in the frame. Furthermore, this configuration helps to reduce processing at the receiving station, because, as one or more container IEs are more likely to be identical over successive management frames, they are less likely to require decryption. As proposed above, a way to identify identical container IEs over time may include using a hash value.

Various criteria to assign the IEs to the two or more container IEs associated with the same encryption scheme may be considered, e.g. given a maximum random number of IEs per container IE, a maximum random length size per container IE, and so on.

In some embodiments, the method comprises, in case it is determined not to aggregate the IE:
encrypting the IE,
embedding the encrypted IE alone within an information field of another container IE, and
embedding the resulting other container IE in the body of the management frame before transmission.

The above mechanisms regarding the Container IEs (e.g. padding and hash) also apply to such container IE including an “isolated” IE, in the way it is not suitable to aggregation with other IEs.

As for the above, the use of a Container IE for such “isolated” IE allows the station to obfuscate that IE, hence to reduce risks that fingerprinting correlates the management frame with another management frame transmitted by the same station.

Hence, more generally in the context of 802.11, this approach concerns a communication method in an 802.11 wireless network, comprising, at a station:
encrypting an information field of an 802.11 information element, IE, to be included in an 802.11 management frame to be transmitted, into an encrypted portion,
embedding the 802.11 IE with the encrypted portion and non-encrypted type and length fields within a body of the 802.11 management frame, and
transmitting the resulting 802.11 management frame over the 802.11 wireless network.

The IEEE802.11 standards family today provides a number of well-defined IEs, as well as plenty well-defined management frames.

In that case, containers are provided as an option, meaning that in some embodiments, a set of one or more 802.11 IEs is encrypted into an encrypted portion that is embedded in an information field of a container IE before the latter is embedded in the body of the 802.11 management frame.

In some embodiments, the method further comprises determining an encryption scheme for one IE to be included in the management frame. In practice, this may be reiterated for each IE to be included in the frame.

In specific embodiments, the encryption scheme includes one or more from an encryption key and an encryption algorithm.

In specific embodiments, the encryption key is a group temporal key, GTK, shared between an AP station managing a Basic Service Set and all non-AP stations of the BSS. The GTK advantageously allows encrypting a single occurrence of the IEs addressed to all associated non-AP stations.

In other specific embodiments, the encryption key is a private transient key, PTK, shared between an AP station managing a Basic Service Set and a single non-AP station of the BSS, or a derivative thereof. The PTK advantageously allows encrypting an occurrence of an IE specific to a given non-AP station.

As mentioned above, different keys, here GTK and PTK (or derivatives thereof) for instance, may be used to encrypt different isolated IEs and/or Container IEs.

In yet other specific embodiments, the determining of the encryption scheme is based on one or more from the addressee or addressees of the management frame (e.g. whether it is a unicast, broadcast or groupcast frame) and a type of the management frame and a type of the IE.

In some embodiments, the method further comprises changing a value of at least one privacy parameter of the station, and responsive to the changing step, modifying at least one obfuscating parameter used to obfuscate the set of one or more IEs within the container IE. Changing an obfuscating parameter modifies a resulting container IE based on the same set of one or more IEs. Here obfuscating means hiding the IEs within the container IE.

In some embodiments, the at least one obfuscating parameter includes one or more from:
an encryption scheme for encrypting the set of one or more IEs. This may be a different cryptographic key and/or a different encryption algorithm;
an order of the IEs within the set of one or more IEs before encryption thereof,
a padding portion added to the set of one or more IEs before encryption thereof, and
removing one or more non-mandatory IEs from the set of one or more IEs before encryption.

As mentioned above, this approach of using the container IEs to modify the fingerprint of the same or similar management frame substantially improves user privacy. The above parameters are key parameters that easily allow the container IEs to vary over time, in particular synchronously to a RCM-based change of the MAC address or any other privacy parameter of the station.

More generally, this approach concerns a communication method in a wireless network, comprising, at a station:
sending multiple management frames, each management frame comprising a container IE that includes an encrypted portion encrypting a set of one or more information elements, IEs, based on an encryption scheme,
changing a value of at least one privacy parameter of the station between the transmission of a first management frame and the transmission of a second management frame, and
responsive to the changing step, modifying at least one obfuscating parameter used to obfuscate the set of one or more IEs within the container IEs of the first and second management frame.

In particular, the at least one obfuscating parameter includes one or more from:
an encryption scheme for encrypting the set of one or more IEs,
an order of the IEs within the set of one or more IEs before encryption thereof,
a padding portion added to the set of one or more IEs before encryption thereof, and
removing one or more non-mandatory IEs from the set of one or more IEs before encryption.

In some embodiments of the invention, the above methods are implemented in an 802.11 wireless network, wherein the one or more IEs and the management frame are respectively 802.11 IEs and an 802.11 management frame, as defined in the IEEE802.11 standards family. In particular, the wireless network and the management frame are according to the IEEE802.11be D2.0 standard.

In some embodiments, the management frame is one from a beacon frame, an association request frame, an association response frame, a disassociation frame, a re-association request frame, a re-association response frame, a probe request frame, a probe response frame, an authentication frame, a de-authentication frame, an action frame. It is to be noted that, in case of Extended Service Set (ESS), keys (GTK, PTK) may already be known by the station when switching form one AP to the other within the ESS (i.e. when roaming). That is why management frames such as a probe request frame (but also other ones in the list) can indeed embed encrypted container IEs or encrypted isolated IEs.

On the reception side, the invention regards a communication method in a wireless network, comprising, at a station:
receiving a management frame over the wireless network,
retrieving a container IE from a body of the received management frame, and
decoding an information field of the retrieved container IE to obtain a set of one or more IEs. The type indication of the Container IE allows for instance the receiving station to identify that IE is a Container IE (hence including other IEs) and not an isolated elementary IE.

The invention also provides a container information element, IE, for a wireless network management frame, comprising
a type indication,
a length field defining a length of the container IE, and
an information field comprising one or more IEs, each having an own type indication, an own length subfield and an own information field, wherein the one or more IEs in the information field are encrypted.

Advantages of this format are similar to those of the methods above.

In some embodiments, an encrypted portion in the information field comprises an encrypted concatenation of the one or more IEs with a padding portion.

In other embodiments, the information field includes a hash field storing a hash value of an encrypted portion embedded the encrypted one or more IEs.

In specific embodiments, the hash field is the first field in the information field.

In yet other embodiments, the information field includes an encryption scheme field signalling an encryption scheme used to encrypt the one or more IEs.

In specific embodiments, the encryption scheme field precedes the encrypted one or more IEs within the information field. Hence the encryption scheme field is not encrypted.

In other specific embodiments, the encryption scheme field is a non-encrypted IE having its own type indication, its own length subfield and its own information field, to specify the encryption scheme field.

The invention also provides a wireless network management frame embedding a container information element, IE, as defined above, in a frame body.

In some embodiments, the frame body include a non-encrypted IE having its own type indication, its own length subfield and its own information field, to signal an encryption scheme used to encrypt the one or more IEs of the container IE.

In specific embodiments, the non-encrypted IE precedes the container IE within the frame body.

In some embodiments, the wireless network management frame is an IEEE802.11 beacon frame and the one or more IEs are IEs according to the IEEE802.11ax D2.0 standard.

Correlatively, the invention also provides a wireless communication device comprising at least one microprocessor configured for carrying out the steps of any of the above methods.

Another aspect of the invention relates to a non-transitory computer-readable medium storing a program which, when loaded into and executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Some embodiments of the present invention are illustrated by way of example, and not by way of limitation, in the figures of the accompanying drawings, in which like reference numerals refer to similar elements and in which:

FIG. 1 illustrates an example of a network system in which embodiments of the invention may be used;

FIG. 2 illustrates the current situation of management frame transmission in an 802.11 wireless network;

FIG. 3 illustrates, using a flowchart, steps to build a management frame according to embodiments of the invention;

FIG. 4 illustrates, using a flowchart, steps to encrypt IEs that are processed in an isolated manner during the operations of FIG. 3;

FIG. 5 illustrates, using a flowchart, steps to encrypt sets of aggregated IEs in Container IEs during the operations of FIG. 3;

FIG. 6 illustrates, using a flowchart, corresponding steps at an AP station or non-AP station receiving the management frame, according to one or several embodiments of the invention;

FIG. 7a illustrates an exemplary management frame format;

FIG. 7b illustrates an information element format;

FIG. 7c illustrates an enhanced IE format according to embodiments of the invention, usable as container IE and/or enhanced isolated IE;

FIG. 7d illustrates an exemplary frame body of a management frame according to embodiments of the invention;

FIG. 8 illustrates, using a flowchart, a dynamic behavior of the obfuscation of IEs by a transmitting station as it changes one or more of its privacy parameters over time, according to embodiments of the invention;

FIG. 9 illustrates the benefits of embodiments of the invention on the scenario of FIG. 2; and

FIG. 10 illustrates an example of a communication device of a wireless network, configured to implement at least one embodiment of the present invention.

### DESCRIPTION OF SOME EMBODIMENTS

The invention improves user privacy in wireless networks by making fingerprinting of management frames more difficult. The invention focuses on the obfuscation of well-known information elements, or IEs, that populate numerous management frames in the wireless networks. An IE in wireless networks is known as a set of three fields or TLV field (standing for Tag-Length-Value field): first, a type indicator or tag identifying the type of IE from amongst a large variety of IEs available (e.g. in a given standard), a length indicator indicating the length of the entire IE and a “value” or “information” or “body” or “payload” comprising the content of the IE, e.g. parameter values for the functioning of the wireless network.

Embodiments of the invention provide that some IEs to be included in a management frame be grouped into sets. Each set of one or more IEs is encrypted into an encrypted portion, which encrypted portion is embedded within the information part of a new IE. This new IE is referred to as “Container IE” because it comprises, in its information part, others IEs, contrary to the “elementary” IEs that are defined in the standards of wireless networks.

One or more of these Container IEs are then embedded in the body or payload of the management frame under construction, which is finally transmitted.

Below, it is made reference to “Container IEs” for those IEs in which other IEs are embedded according to the teachings of the invention, and made merely reference to “IEs” for those IEs that are subject to the process of the invention in view of possibly embedding them in container IEs. These mere IEs are usually defined in the standards as elementary IEs which do not comprise other IEs in their information field.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or non-AP STA).

While the examples and embodiment are described in the context of Wi-Fi networks (according to the IEEE802.11 Standards family or to one of these standards), the invention may be used in any type of wireless networks, like, for example, mobile phone cellular networks (3G/UMTS, 4G/LTS, 5G/NR) that implement very similar mechanisms.

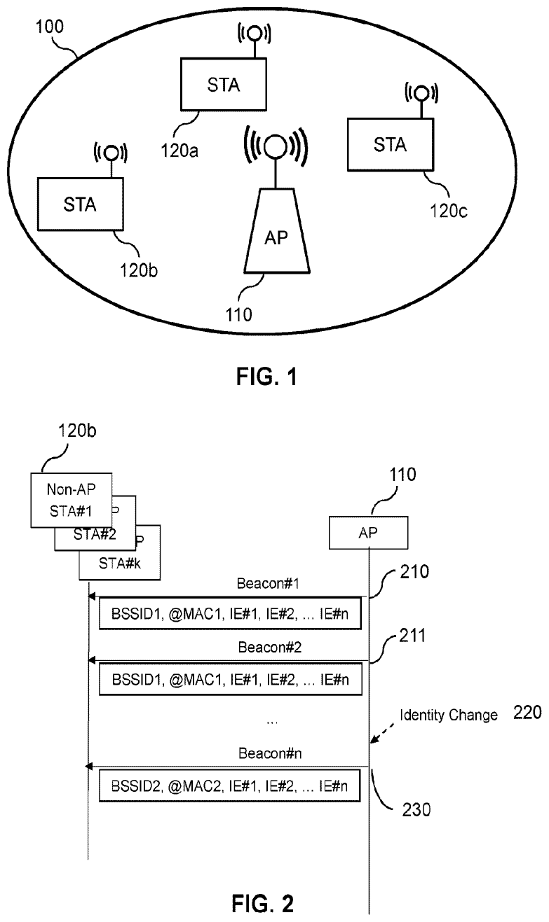

FIG. 1 illustrates an example of a wireless network system in which embodiments of the invention may be used.

FIG. 1 represents an 802.11 network (i.e. a Wi-Fi network) system 100 comprising four wireless devices: an access point (AP) station 110 and three non-AP stations (non-AP STAs) 120a, 120b, 120c. Of course, the number of non-AP stations 120a, 120b, 120c may be different from three.

Although such 802.11 stations are shown as standalone 802.11 stations, they may also correspond each individually to a multi-link device, MLD, or to an affiliated station of such MLD. The MLD and its operations are described in the 802.11be D2.0 standard. A MLD is a logical entity that has more than one affiliated station (STA) and has a single medium access control (MAC) service access point (SAP) to logical link control (LLC), which includes one MAC data service. An AP MLD is thus made of multiple affiliated APs whereas a non-AP MLD is made of multiple affiliated non-AP STAs. The affiliated STAs in both AP MLD and non-AP MLD can use 802.11 mechanisms to communicate with affiliated STAs of another MLD over each of the multiple communication links that are set up.

For ease of explanation, the description below only refers to “stations”, regardless of whether it is a standalone 802.11 station, an 802.11be MLD or an 802.11be station affiliated to such MLD.

The AP station 110 provides wireless connections between the non-AP stations 120a, 120b, 120c and a wider network, such as the Internet. The connection of a non-AP station 120a, 120b, 120c to the AP station 110 is performed by a standardized process called association. Once a non-AP station 120a, 120b, 120c is associated with the AP station 110, the non-AP station 120a, 120b, 120c can send data to the network and receive data from the network through the AP station 110.

The AP station 110 may comprise, be implemented as, or known as a Node B, Radio Network Controller (RNC), evolved Node B (eNB), 5G Next generation base station (gNB), Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology. It can be a standalone product or it may be integrated in a device, for instance a broadband remote access server (BRAS).

A non-AP station 120a, 120b, 120c may comprise, be implemented as, or known as a subscriber station, a subscriber unit, a mobile station (MS), a remote station, a remote terminal, a user terminal (UT), a user agent, a user device, a user equipment (UE), a user station (STA), or some other terminology. In some implementations, a non-AP station 120a, 120b, 120c may be or may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or a smartphone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station 120a, 120b, 120c may be a wireless node. Such wireless node may provide, for example, connectivity for or to a network (e.g., a wide area network such as the Internet or a cellular network) via a wired or wireless communication link.

The AP station 110 manages a set of stations that together organize their accesses to the wireless medium for communication purposes. All the stations (AP station 110 and non-AP station 120a, 120b, 120c) form a service set, which may be referred to as basic service set, BSS (although other terminology can be used). It is noted that the AP station 110 may manage more than one BSS: each BSS is thus uniquely identified by a specific basic service set identifier (BSSID) and managed by a separate virtual AP station implemented in the physical AP station 110.

In order to ensure user privacy, the AP station 110 and the non-AP STAs 120a, 120b, 120c have been configured with a dot11MACPrivacyActivated set to true. This flag is a Management Information Base (MIB) variable controllable by an external management entity to define whether the non-AP STA can apply (variable set to true) specific mechanisms for enhancing the privacy at MAC level, including the RCM procedure, or not (variable set to false). The use of this variable (alternatively another variable may be defined) may be extended to mechanisms for enhancing the privacy of other privacy parameters than the sole MAC addresses of the stations. In the context of the present invention, it is also extended to the implementation of the mechanisms according to the present invention.

A “legacy” station therefore refers below to a station which does not implement the invention, e.g. which is not able to handle Container IEs as proposed above, due to an absence of this flag or due to this flag set to false.

An exemplary user privacy management at a station through a RCM procedure includes for the station to dynamically change the value of its MAC address into a new random value. The use of a shared pseudo-random function between the AP station and a non-AP station allow them to obtain and use the same new random value as new MAC address for one of them. Such new MAC address known by both stations allow them to efficiently keep going on communicating, while any observer should believe that this is a new communication between different stations. Such user privacy management may be extended to any other privacy parameter of an AP station (e.g. Scrambler Seed, Beacon Interval, BSS Color) or of a non-AP station (Sequence Number, Packet Number, Association Identifier AID, Scrambler Seed).

FIG. 2 illustrates the current situation of management frame transmission in an 802.11 wireless network, taking the particular example of beacon frames by an AP station to neighbouring non-AP stations, be them already associated or not, legacy stations or not. The same finding can be made in other wireless networks than 802.11 networks (e.g. 5G networks), as well as with other management frames than the beacon frames (e.g. probe request frames).

A beacon frame, as represented by references 210, 211, 230, contains all the information about the 802.11 wireless network. Beacon frames are transmitted periodically, they serve to announce the presence of a wireless LAN and to synchronize the non-AP stations of the Basic Service Set, BSS, managed by the AP station.

A beacon frame therefore includes a BSS Identifier, BSSID, uniquely identifying the BSS as well as the MAC address of the transmitting AP station plus plenty others information elements IEs kept in clear text (the 802.11ax™-2021 Std defines 88 IEs; the 802.11be D2.0 Std defines four additional IEs to 802.11ax). Exemplary IEs in a beacon frame include EDCA Parameter Set IE (identified with Element ID=19), MU EDCA Parameter Set IE (Element ID=83), Service Set Identifier IE (Element ID=4), Beacon Interval IE (Element ID=2), HT Capabilities IE (Element ID=33), HT Capabilities IE (Element ID=77), and so on. The IEEE802.11 standards family describes more than 300 different types of IE. If each beacon frame does not contain an instance of each of those IEs, several instances of a given type can be present.

Beacons 210 and 211 sent by the AP station 110 and decoded by the non-AP stations 120b are uniquely identified by its BSSID=BSSID1 and the MAC address @MAC1 of the AP station 110. Those beacon frames also contain information stored in different Information Elements (IE #1 to IE #n).

Thanks to the RCM-based user privacy procedure mentioned above, the MAC address and the BSSID, as privacy parameters, can be changed into new random values. This is referenced by event 220 in the Figure. This intends to protect the AP station (typically a mobile AP in a smartphone) from being tracked by an observer as the latter should not be able to correlate the former and new BSSIDs and MAC addresses.

As from this change, the new beacon frames, as reference 230, are uniquely identified by BSSID2 (different from BSSID1) and MAC address @MAC2 (different from @MAC1), and still contain Information Elements IE #1 to IE #n in clear text. The beacon frames periodically sent by the AP station remain as reference 230 until the BSSID and the MAC address are changed again, using the RCM procedure.

As apparent from beacon frames 210, 211 on one side and beacon frame 230 on the other side, despite different BSSIDs and @MAC, the content of the beacon frames does not change that much over time: the lengthy list of IEs IE #1 to IE #n remain identical (or nearly identical as some IEs may be added or removed, but usually in a low proportion compared to the total number of IEs). It turns out that this lengthy list can be used as a “signature” or fingerprint of the AP station.

As a consequence, an observer may correlate the new BSSID value (BSSID2) with the former BSSID value (BSSID1) using a fingerprint based on the set of IEs populating the management frame. Such correlation may use either the content of those numerous IEs or the types of the IEs or both.

Although the fingerprinting of such a management frame allows an observer to correlate former and new MAC addresses (more generally privacy parameters) of the transmitting station when it changes its MAC address, it may also allow the observer to correlate former and new MAC addresses of the addressee or receiving station in case of unicast management frame, when this station also changes its MAC address.

The same issue arises for other management frames than the beacon frames. As an example, when roaming between two BSSs of an ESS (Extended Service Set) deployed in a company premises, the management frames used for the re-association procedure (re-association request frame) to the target BSS also allows an observer to track a moving station thanks to fingerprinting technics even if it changes its privacy parameters when roaming (@MAC, or AID for instance).

The exemplary scenario of FIG. 2 therefore shows there is a need to enhanced protection of the privacy of user devices in wireless networks.

As mentioned above, obfuscation of the IEs in the management frames is proposed that involves new container IEs dedicated to embed multiple IEs to be transmitted. This allows these multiple IEs to be entirely encrypted, hence hiding not only their values but also their type indication, while keeping in clear text the type indication and length value of the container IEs (not-encrypted indications which allow the receiving stations to select and process only the IEs of the management frame they want).

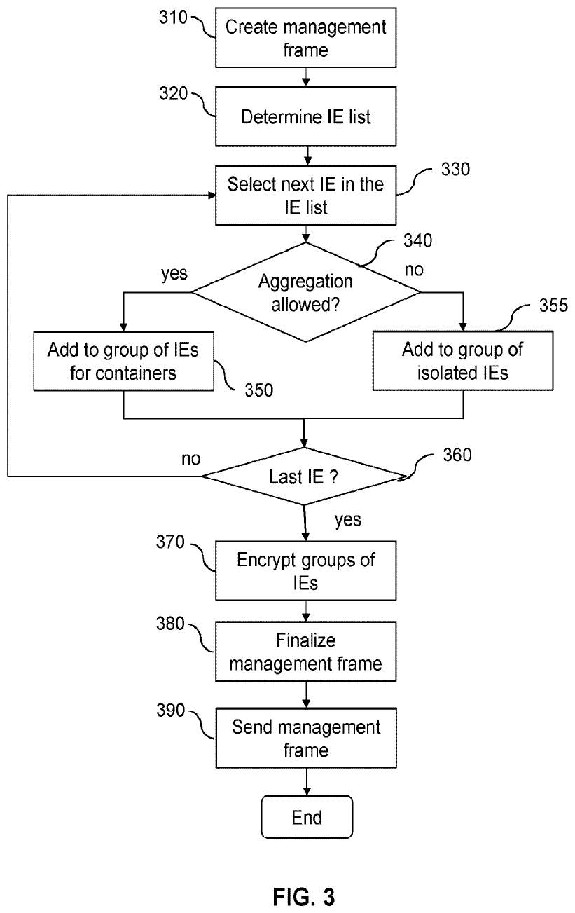

FIGS. 3 to 5 illustrate, using flowcharts, embodiments of a communication method in a wireless network, which comprises, at a station:
obtaining a set of one or more information elements, IEs, to be included in a management frame to be transmitted,
encrypting the set of one or more IEs into an encrypted portion,
embedding the encrypted portion within an information field of a container IE,
embedding the resulting container IE in a body of the management frame, and
transmitting the resulting management frame over the wireless network.

The station may be any of the AP station and of the non-AP stations.

Correspondingly, a receiving station may implement at its end a communication method in a wireless network, comprising, at the receiving station:
receiving a management frame over the wireless network,
retrieving a container IE from a body of the received management frame, and
decoding an information field of the retrieved container IE to obtain a set of one or more IEs.

By obfuscating the IEs with container IEs, it is more difficult for an observer to perform fingerprinting on the management frames.

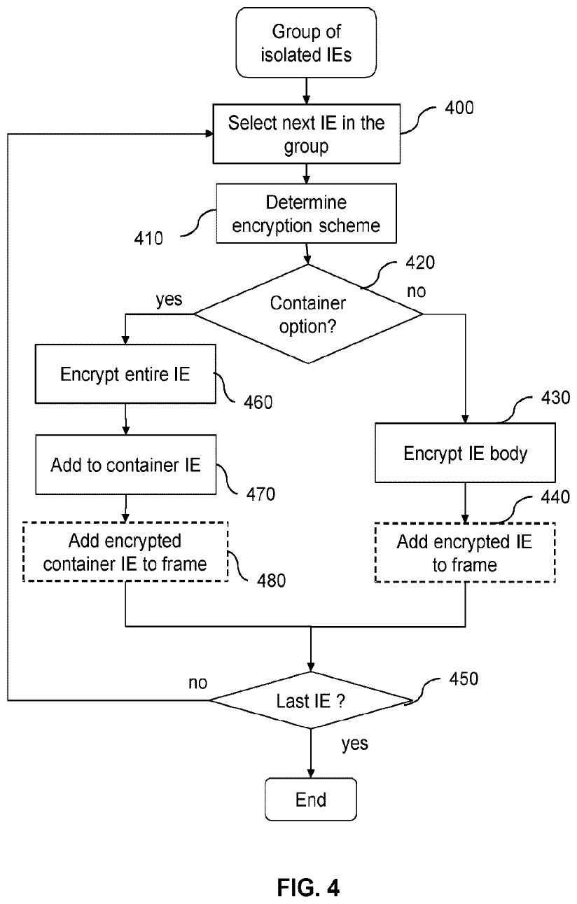

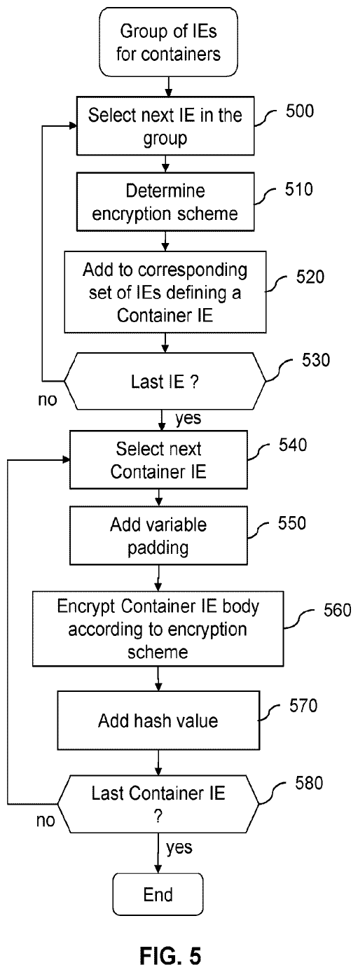

FIG. 3 first illustrates steps to build a management frame according to embodiments of the invention. FIG. 4 illustrates steps to encrypt IEs that are processed in an isolated manner during the operations of FIG. 3. FIG. 5 illustrates steps to encrypt sets of aggregated IEs in Container IEs during the operations of FIG. 3.

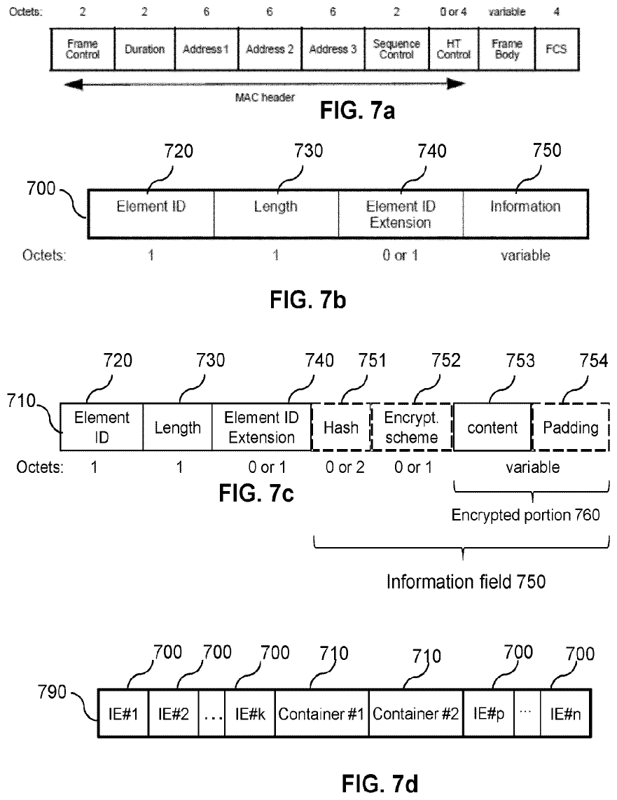

With reference to FIG. 3, a step 310, the station creates the management frame following the conventional format as shown for instance in FIG. 7a. A description of this format can be found in the IEEE802.11 standards family and therefore is not described with more details here.

It is only noted that the Frame Body is the section of the management frame dedicated to receive the IEs to be included in the management frame. Therefore, the content of the Frame body is filled in according to steps 320 to 380 described below, while the fields of the MAC header are specified in present step 310 using conventional MAC header signalling.

The triggering event to build a management frame is out of scope of the present invention.

At step 320, the station determines the list of IEs to be included in the management frame (Frame Body) to be transmitted, below IE list.

The IE list usually depends on the type of management frame created (Beacon frame, association request frame, etc.), but also on the current status of the station. The definition of the list of information element to be added to the frame is out of scope of the current document, and mainly relies on the IEEE802.11 specification.

Each IE of the IE list is prepared with its type indication, length and information field, according to the conventional IE format (as shown in FIG. 7b).

At step 330, the station selects the (first) next IE of the IE list that becomes the current IE and then perform step 340.

At step 340, the station determines whether to aggregate the current IE with other IEs in a container IE before encryption or to process the current IE as an isolated IE, i.e. without aggregation with other IEs in a container IE. Thanks to the loop from step 360 to step 320, this determination is made for each IE to be included in the management frame.

Various criteria may be involved to perform the determination.

In first embodiments particularly suitable for beacon frames but not only, this decision can be based on whether the content of the current IE is necessary for a non-associated non-AP station to associate with the AP station or not.

Indeed, as such non-AP station does not yet share encryption keys with the AP station, the IEs they need must remain in clear text in the beacon frame. This is for example the case for the SSID IE mentioned above.

On the other side, an IE not necessary for non-associated non-AP stations may include the EDCA Parameter Set IE mentioned above as it is useful for associated non-AP stations only. Such an IE may therefore be aggregated and encrypted.

In these embodiments, the determining is therefore based on whether the current IE is used by a station addressee of the management frame to associate with a station transmitting the management frame.

Such a usage of the IEs can be indicated in the corresponding IE specifications within the IEEE802.11 standards documents. The usage may depends on the type of management frame. It turns out that the determining may also be based on a type of the management frame, and optionally on a type of the current IE.

It is to be noted that the IEEE802.11 standards currently define, for each type of management frame, the list of IEs that are mandatory or optionally present. Mandatory IEs may therefore be seen as needed by all addressee stations, while optional IEs have specific usefulness for some addressee stations, implicitly some already associated stations. Therefore, the determining may be based on whether the current IE is mandatory or optional according to the IEEE802.11 standards family.

In second embodiments, the determining may be based on a type of the management frame, and optionally on a type of the current IE. For some management frame types, all the IEs may be aggregated while for other types of management frames, no IE can be aggregated.

For example, for the re-association frames used during the roaming process of a non-AP station from one AP station to another AP station of the same ESS, all IEs in the re-association frame could be aggregated and further encrypted using the PTK (private key used for the data packet encryption) since this key is already shared between the different AP stations of the ESS and the non-AP station concerned. This exemplary scenario allows the non-AP station to avoid being tracked when roaming form one AP station to another AP station of the same ESS.

Of course, other criteria may be implemented within the scope of the invention. For example, the IEs to be aggregated may be chosen randomly. In another example, the N first IEs (according to the order indicated in the standards) can be dedicated to aggregation while the remaining ones are not (or the reverse). And so on.

More generally, it may be determined that some IEs can be aggregated, some IEs must remain isolated in clear form and some IEs can be isolated and encrypted.

In case it is determined to aggregate the current IE at step 340, it is added to the group of IEs dedicated to Container IEs. This is merely the group of IEs to aggregate or group of “aggregation IEs”. This is step 350.

In case it is determined not to aggregate the current IE at step 340, it is added to the group of isolated IEs, meaning they will be processed below in an independent manner (hence with no risk of aggregation). This is step 355.

After steps 350 and 355, step 360 determines whether the current IE is the last IE in the IE list. If not, the process loops back to step 320 to process the next IE of the IE list; otherwise next step is step 370 consisting in encrypting, when appropriate, the IEs of the two groups formed at steps 350 and 355.

FIG. 4 illustrates steps to encrypt the isolated IEs (if needed) of the group formed at step 355, while FIG. 5 illustrates steps to encrypt the IEs of the group for Container IEs as formed at step 350.

Once the encryptions have been made (description below, filling in the Frame Body of the frame with all the IEs), the management frame is finalized at step 380. This may include embedding the “encrypted” container IEs and isolated IEs resulting from step 370 in the body of the management frame.

This embedding preferably follows the order of the IEs as defined in the standards to preferably facilitate any resolving of dependencies between IEs. As described below, the Container IEs according to the invention may be defined using a new type of IE, preferably having a high order in order to locate the Container IEs at the end of the Frame Body. Hence, the isolated IEs precede the Container IEs within the Frame Body. Of course, other variants may be contemplated, e.g. with an order of the Container IEs placing them within the isolated IEs, or with a random order de-correlated from the order of the IEs as defined in the standards.

Also the FCS (frame check sequence) is computed when the frame content is completed, at step 380.

Once the management frame is ready, it is sent by the station over the wireless network. This is final step 390.

Turning now to the encryption 370 of the groups of IEs as shown in FIG. 4, the process starts by selecting at step 400 the next (initially first) IE of the group, referred to as current isolated IE.

An encryption scheme or “level” is determined at step 410 for the current isolated IE. This determines whether or not the information in the current isolated IE can be encrypted or must remain in clear text (e.g. for unassociated stations as mentioned above), and in the affirmative of a possible encryption, it determines the encryption algorithm and key to be used.

The encryption scheme or “level” can be different for each isolated IE processed, or identical for a set of isolated IEs (potentially the same for all isolated IEs of the group).

In some embodiments, the encryption scheme or “level” may be predefined given the IE considered. Hence, it is determined an encryption scheme for encrypting (or not) the current isolated IE, based on a predefined table matching encryption schemes with respective IEs.

In other embodiments, the encryption scheme or “level” is selected based on the type of frame or based on the type of the current isolated IE. All IEs that need to remain in clear text for unassociated station may be instance be assigned a NULL or “0” encryption level scheme or “level”, meaning no encryption.

As an example for an encryption where the encryption algorithm is prefixed (e.g. the same for all IEs to be encrypted) and thus only the encryption key is to be determined, the encryption key (e.g. the GTK shared between the AP station managing the BSS and all the non-AP stations of the BSS or the PTK shared between the AP station and a single non-AP station of the BSS) can be determined on an IE type basis. If the current isolated IE is to be addressed to all non-AP station of the BSS, an encryption scheme with the GTK (e.g. encryption scheme “1”) may be chosen, while if the current isolated IE is addressed to a specific non-AP station or from it, an encryption scheme with the PTK associated with this non-AP station (e.g. encryption scheme “2”) may be chosen. In this example, the encryption scheme or “level” is determined based on the addressee or addressees (i.e. receiving station or stations) of the management frame.

The exemplary scheme allocation is summarized in the following table:

| Encryption | | |
|---|---|---|
| scheme | Encryption key | description |
| 0 | Not applicable | No encryption |
| 1 | GTK | Encryption of element addressed all the stations of |
| | | the BSS (typically for beacon information element). |
| | | The Groupwise Temporal Key is used. |
| 2 | PTK | Encryption of elements addressed to a single station. |
| | | The Private Transient Key of the station is used. |
| . . . | . . . | . . . |
| 255 | Vendor specific | Vendor specific |

It is recalled that the GTK is a secret key that is exchanged (secretly) between the AP and the non-AP stations, while the PTK is obtained locally (at the AP and the non-AP station) based on an exchanged secret. Although the PTK may be used in the present invention, any key derived from the PTK (“derivative key”), e.g. the Key Encryption Key, KEK, may also be used. A derivative of the PTK may advantageously be lighter-smaller key (e.g. 128 bits) for the calculation than the PTK itself (384 or 512 bits). Therefore, in the present detailed description, “PTK” may mean the PTK key or any of its derivatives, be it the KEK or not.

The number of encryption schemes available may vary from one management frame to the other. The encryption schemes can vary between IEs of the same management frame, e.g. different encryption algorithms (in addition to different encryption keys) can be determined for different types of isolated IEs. Exemplary encryption algorithms include 802.1X, PSK and AES.

Following step 410 is optional step 420 where it is determined the opportunity to obfuscate the current isolated IE using a dedicated Container IE. This may be done for isolated IEs that are to be encrypted (hence encryption scheme different from “0” in the above example). Decision to obfuscate the current isolated IE to be encrypted may be based on the addressee or addressees of the management frame and/or a type of the management frame and/or a type of the current isolated IE. For example, all the isolated IEs specific to non-AP stations (i.e. encryption scheme equal to “2”) may be embedded in respective Container IEs, while the isolated IEs addressed to all the non-AP stations (i.e. encryption scheme equal to “1”) may remain as individual IEs in the management frame. Of course, the opposite is possible.

In variants, the choice of embedding the isolated IEs in respective Container IEs or not may be random.

If it is decided not to embed the current isolated IE in a dedicated Container IE (branch “no” of step 420), next step is step 430 where the information field of the current isolated IE is encrypted according to the determined encryption scheme. Hence no encryption is made if the encryption scheme is “0”. At this stage, the type indication and length field of the current isolated IE remain in clear text (i.e. not encrypted).

Conventional encryption is made using the determined encryption algorithm and the determined encryption key.

An IE having an encrypted portion and non-encrypted type and length fields is therefore obtained.

In some embodiments, the obtained IE follows the conventional IE format 700 as depicted in FIG. 7b. The encrypted portion forms the entire information field of the resulting IE.

In sub-embodiments, the encryption scheme (e.g. value “0”, “1” or “2” in the above example) is not signaled, meaning it is implicit. This is for instance the case when the encryption scheme is predefined for the IEs and/or the management frames.

In other sub-embodiments when the same encryption scheme is used to all the isolated IEs (i.e. IEs not being container IEs), the encryption scheme may be signaled in a dedicated additional IE (hence common to all isolated IEs). Preferably this “encryption scheme” IE is located in the Frame Body before any encrypted isolated IE.

In these embodiments, only the information field of the current isolated IE is encrypted with the selected encryption key and the information field of the output IE is set with the result of this encryption. The type and length of the current isolated IE are not encrypted and remain freely available to any station, including an observer.

In other embodiments, the obtained IE follows an extended IE format 710 as shown in FIG. 7c. The conventional subfields Element ID 720, Element ID Extension 740 (forming together the IE Type indication), Length 730 and Value (or body or information) 750 are shown. This structure TLV advantageously allows backwards compatibility of the decoding of the management frames by legacy stations (stations not implementing the invention).

The information field 750 of the current isolated IE is enhanced to include the encrypted portion 760 (encrypting the initial information field, shown as 753, of the current isolated IE) and also subfield 752 signaling the encryption scheme used. In the format shown, the encryption scheme of the encrypted portion 760 is signaled in a subfield 752 preceding the encrypted portion within the information field 750 of the IE 710.

Optionally, a hash value 751 can be computed as explained below with respect to the Container IEs. Also, as an option, padding, shown as 754, may be added to the information field 753 before encryption, as described below, in order to obtain the encrypted portion 760.

Next to step 430 is step 440 optionally represented here for clarity reasons, which is part of step 380. When the process of FIG. 4 follows the order of the IEs contemplated for insertion in the body of the management frame, step 440 may merely add (embed) the current isolated IE resulting from step 430 as a next IE in the Frame Body.

Next step is step 450 which determines whether the current isolated IE is the last IE in the group of isolated IEs. If not, the process loops back to step 400 to process the next isolated IE of the group; otherwise the process ends.

Back to step 420, if it is decided to embed the current isolated IE in a dedicated Container IE (branch “yes”), next step is step 460 where the entire current isolated IE (i.e. type indication, length and information field) is encrypted using the determined encryption scheme.

Next at step 470, the resulting encrypted IE is embedded alone (i.e. without other IE of the initial IE list) within an information field of a container IE 710, as shown in FIG. 7c. In this case, the result of the encryption is stored as part 760 of field 750 within Container IE 710. In this embodiment, the type and length of the current isolated IE is hidden in the Container IE 710, thereby obfuscating them.

A Container IE has a Type indication (i.e. Element ID plus Element ID Extension fields) different from all the IEs of the initial IE list, therefore allowing such Container IEs to be easily identifiable.

Subfield 752 preceding the encrypted portion 760 within the information field 750 of the IE 710 signals the encryption scheme used. In some embodiments, subfield 752 may be a non-encrypted IE signaling the encryption scheme. In other words, the encryption scheme of the encrypted IE is signaled in a non-encrypted IE preceding the encrypted IE within the Container IE.

Optionally, a hash value 751 can be computed as explained below with respect to the Container IEs. Also, as an option, padding 754 may be added to the information field 753 before encryption, as described below.

Next to step 470 is step 480 optionally represented here for clarity reasons, which is part of step 380. Step 480 may merely add (embed) the Container IE embedded the current isolated IE resulting from step 470 as a next IE in the Frame Body of the management frame.

Next step is step 450.

This ends the encryption of the isolated IEs.

Turning now to the encryption 370 of the groups of aggregation IEs to be aggregated as shown in FIG. 5, i.e. those IEs for which it has been determined at step 340 it can be aggregated with other IEs if any, the process starts by selecting at step 500 the next (initially first) IE of the group, referred to as current aggregation IE.

It is now searched to determine an encryption scheme for the current aggregation IE and select a container IE associated with the same encryption scheme as the determined encryption scheme. This is to group all the aggregation IEs that can be encrypted using the same encryption, as embodiments of the invention only signal a single encryption scheme per Container IE grouping plural IEs.

Therefore, at step 510, similar to step 410 above, an encryption scheme or “level” is determined for the current aggregation IE, e.g. any of values “0”, “1” and “2” of the above example.

Once the encryption scheme is known, the current aggregation IE is assigned to a Container IE corresponding to that encryption scheme, at step 520. In practice, it is added to a set of aggregation IEs for a Container IE to be encrypted using the encryption scheme.

If such Container IE (hence associated set of IEs) already exists, it is chosen.

In embodiments, a single container IE associated with a given encryption scheme is provided within the body of the management frame. It is designed to aggregate all the aggregation IEs of the management frame that are associated with the encryption scheme. In that case, the current aggregation IE is added to that specific single container IE.

In other embodiments implement an additional obfuscation algorithm, several containers with the same encryption can be created based on a different policy. In other words, two or more container IEs associated with the same encryption scheme are embedded within the body of the management frame, to include all the IEs that are associated with the encryption scheme.

For instance, the station may choose a maximum random number of aggregation IEs per container IE or a maximum random length size per container IE. The station thus creates a new container with the same encryption level of the current aggregation IE when the criterion is met, e.g. the total number of IEs already aggregated in the existing container exceeds the random value chosen by the station.

Other criteria may be contemplated, including a fully random approach, performance-based or privacy-based or overhead-based approach, or a fixed number of container IEs per encryption scheme. For example, N (integer) container IEs are available for a given encryption scheme. An assignment of an aggregation IEs to one or the other of these N container IEs may be made randomly or on a round-robin basis.

In any case, the current aggregation IE is added to the set of aggregation IEs corresponding to the appropriate container IE.

If no Container IE (hence associated set of IEs) for the encryption scheme already exists, it is created, and the current aggregation IE is the first IE in the associated set of IEs. In that case where no container IE associated with the determined encryption scheme exists, a new container IE associated with the determined encryption scheme is created and the current aggregation IE is added to the new container IE.

Once the current aggregation IE has been assigned to a set of IEs corresponding to a Container IE, next step is step 530 which determines whether the current aggregation IE is the last IE in the group of aggregation IEs. If not, the process loops back to step 500 to process the next aggregation IE of the group; otherwise next step is step 540.

Once all the aggregation IEs have been assigned to a Container IE, each of the Container IEs have to be encrypted through steps 540-580.

The encryption starts by selecting at step 540 the next (initially first) Container IE (referred to as current Container IE), the associated set of which has been populated with one or more aggregation IEs.

The current set of aggregation IEs is therefore a concatenation of IEs, preferably in the order specified by the applicable standard. In a variant, the order may be a random one.

Optional step 550 consists to add padding at the end of the concatenation of IEs, in order to provide a high level of obfuscation of the IEs. In other words, a padding portion 754 (FIG. 7c) is added to the set of one or more IEs, shown as 753 in the Figure, before encrypting them together into the encrypted portion 760. Indeed, padding makes fingerprinting of the management frame even more difficult because two container IEs, containing the exact same IEs with the same values and in the same order, will have a different length and content.

Enhanced obfuscation is obtained by using different padding 754 over time and over Container IEs. In this respect, a length and/or a binary content of the padding portion is variable between container IEs and/or over time, preferably the length and/or binary content are/is randomly determined to set the padding portion 754.

Once the optional padding has been added, step 560 consists in encrypting the (optionally padded) concatenation of IEs of the current Container IE into an encrypted portion as shown by reference 760 in FIG. 7c. The encryption is based on the encryption scheme (algorithm and key) associated to the current Container IE.

Optional field 752 signals that encryption scheme, either using a mere scheme identifier (e.g. values “0”, “1” and “2” of the above example) or using a non-encrypted “encryption scheme” IE. In these embodiments, the encryption scheme is signaled in a subfield 752, optionally in a non-encrypted IE, preceding the encrypted portion 760 within the information field 750 of the container IE 710.

In variants, various types of Container IEs may be provided depending on the encryption scheme. For example, using the above example (encryption schemes “0”, “1” and “2”), three types of Container IE (i.e. Element ID 720 plus Element ID Extension 740) define three different values, each being thus associated with a given encryption scheme. This allows signaling the encryption scheme together with the Container IE, without additional signaling costs.

Field 752 can be omitted when the encryption scheme is predefined (using e.g. an encryption scheme table as mentioned above) or when its signaling is made outside the Container IE itself. The latter option is useful for instance to save signaling costs, when the same encryption scheme applies for plural or all Container IEs. In that case, the encryption scheme can be signaled in a non-encrypted “encryption scheme” IE preceding the container IE 710 within the body of the management frame.

Next optional step 570 consists in calculating a hash of the encrypted portion 760, possibly including encryption scheme field 752, and then in including the calculated hash in a dedicated and optional subfield 751 preceding the encrypted portion 760 within the information field 750 of the container IE 710. As shown, the hash field 751 may be the first subfield within the information field 750. The hash value is not encrypted to be available, at low costs, to the receiving station.

The hash may be computed using an algorithm of the SHA family like SHA-256. In one embodiment, the two first octets of the result of the SHA-256 algorithm applied to the encrypted portion 760 are store in the hash field 751.

The presence of the hash value allows the receiving station to easily determine whether the decoding of the encrypted part 760 is useful or not (e.g. when there is no modification of the content since the last decoding of this container IE from a previous management frame).

Once the hash value is added to the Container IE, the length of the resulting encrypted elements is computed and then stored in Length field 730.

Next step is step 580 which determines whether the current Container IE is the last Container IE to be processed. If not, the process loops back to step 540 to process the next Container IE; otherwise the process ends.

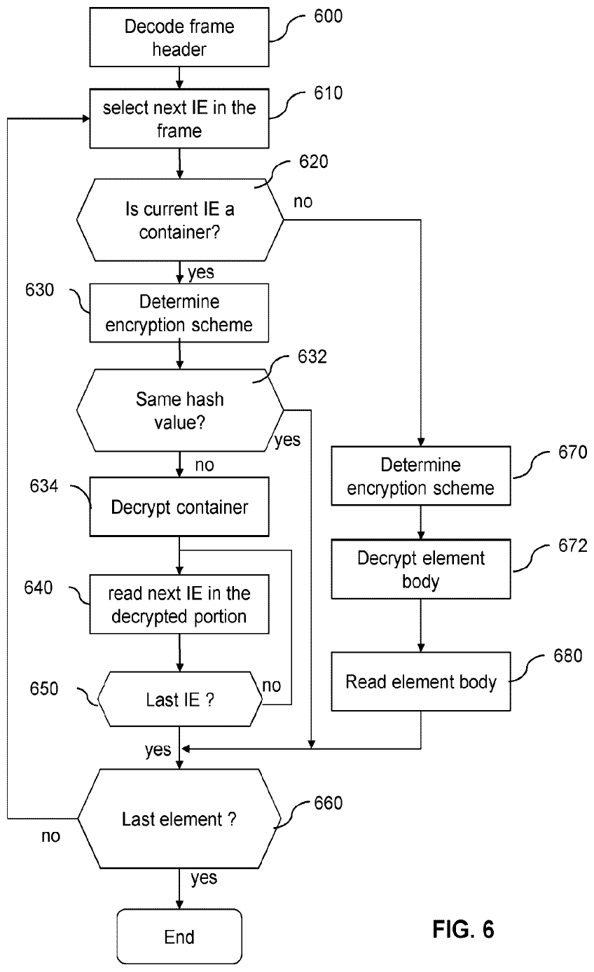

FIG. 6 illustrates, using a flowchart, corresponding steps at an AP station or non-AP station receiving the above management frame, according to one or several embodiments of the invention.

This regards a communication method in a wireless network, which comprises, at a receiving station:
receiving a management frame over the wireless network,
retrieving a container IE from a body of the received management frame, and
decoding an information field of the retrieved container IE to obtain a set of one or more IEs.

The obtained IEs can then be used in a conventional manner, because they have been fully decrypted.

It is to be noted as mentioned above that some IEs may be isolated and non-encrypted in the body of the management frame, meaning that those IEs may be directly retrieved and used by legacy receiving stations that do not implement the invention.

The process starts at step 600 with the decoding of the header of the received management frame and the extraction of the Frame Body part (according to the format of FIG. 7a).

Next step 610 consists for the receiving station to select the next IE within the Frame Body. This may be a conventional non-encrypted IE, or an isolated IE with an encrypted information field but non-encrypted type and length fields, or a Container IE (including one or more IEs), or an “encryption scheme” IE as defined above. In any case, the two or three first octets corresponding respectively to the Element ID, Length and optionally Element ID Extension (depending on the value of Element ID) subfields are in clear text.

Reading these two or three first not-encrypted octets allows the receiving station to parse the current IE.

Next step is step 620 where the receiving station determines whether the current IE is a Container IE 710 based on the Element ID (plus Element ID Extension if appropriate).

In case it is determined that the current IE is a Container IE 710 (branch “yes” at step 620), next step is step 630 where the encryption scheme of that current Container IE is determined.

According to the signaling embodiment used by the transmitting station (step 470 or 560), the encryption scheme may be obtained:
based on a predefined table matching encryption schemes with respective IEs and/or frame type,
from subfield 752 of the current Container IE,
from a non-encrypted “encryption scheme” IE (identifiable through a dedicated Type indication) preceding the current Container IE, or
from the Type indication (Element ID plus Element ID Extension) of the current Container IE.

Once the encryption scheme is known, next step is optional step 632 where the hash value (subfield 751), if any, is retrieved and compared to the last hash value or values obtained (and stored internally) for preceding Container IEs having the same Type indication and same encryption scheme. If it is the same value, there is no need to decrypt the Container IE, hence next step is step 660; otherwise next step is step 634 where the encrypted portion 760 of the Container IE is decrypted using the determined encryption scheme (algorithm and key).

This step includes no decryption when the encryption scheme is “0” (or absent), i.e. the transmitting station has not encrypted the IEs of that Container IE.

The receiving station can then read each IE aggregated in the decrypted portion (possibly by removing the padding portion 754), as shown by steps 640 and 650. Conventional use of the read IEs is then performed by the receiving station.

Next step is step 660 which determines whether the current IE is the last IE in the Frame Body of the received management frame. If not, the process loops back to step 610 to process the next IE of the frame; otherwise the process ends.

Back to step 620, in case it is determined that the current IE is not a Container IE but an isolated IE (branch “no”), next step is step 670 where the encryption scheme of that current isolated IE is determined.

According to the signaling embodiment used by the transmitting station (step 430), the encryption scheme may be obtained:
based on a predefined table matching encryption schemes with respective IEs and/or frame type,
from subfield 752 of the current IE, or
from a non-encrypted “encryption scheme” IE (identifiable through a dedicated Type indication) preceding the current IE (and more generally before any encrypted isolated IE).

Once the encryption scheme is known, next step is step 672 where the encrypted portion forming the information field 750 of the current IE is decrypted using the determined encryption scheme (algorithm and key).

This step includes no decryption when the encryption scheme is “0” (or absent), i.e. the transmitting station has not encrypted the information field of that current IE.

The receiving station can then read the content of the current IE at step 680. Conventional use of the read content is then performed by the receiving station.

Next step is step 660 described above.

FIG. 7d illustrates an exemplary Frame Body 790 of a management frame (FIG. 7a) when implementing some embodiments of the invention.

As readily apparent from this Figure, the Frame Body may mix isolated IEs and Container IEs in the meaning of the invention. Of course, this is only an illustrative example, while other embodiments may have only Container IEs or only isolated/individual IEs, or more or less IEs compared to Container IEs. Also any other order between the isolated IEs and the Container IEs may be contemplated, including having these various information elements organized according to their Type order as defined in the standard, or having all the isolated IEs before the Container IEs.

In some embodiments, one or more IEs may be “encryption scheme” IEs dedicated to the signaling of the encryption applicable to one or more subsequent IEs and/or Container IEs.

It is worth noting that each isolated or Container IE can be encrypted or not and potentially using different encryption schemes.

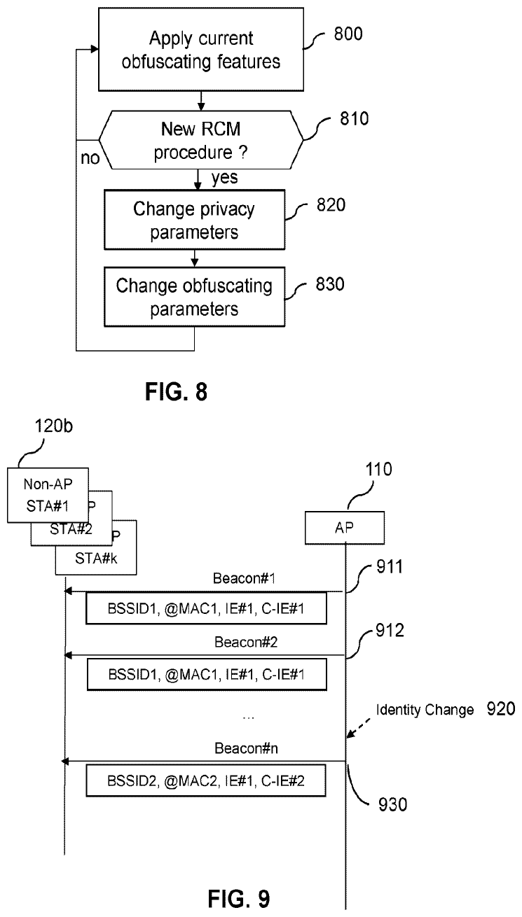

FIG. 8 illustrates, using a flowchart, a dynamic behavior of the obfuscation of the IEs by the transmitting station as it changes one or more of its privacy parameters over time, using for example the RCM procedure (or an enhanced version of it).

A transmitting station therefore applies this process in parallel to those of FIGS. 3, 4 and 5. This process aims at modifying some parameters in those other processes, in order to produce a substantial different management frame (or Container IE) for the same (or the like) IEs to be included, when the privacy parameters are changed.

At step 800, the station applies obfuscating parameters or features to obfuscate the IEs in its management frame. These obfuscating features include for example:
a given encryption scheme for encrypting the set of one or more IEs associated with a Container IE. This may be a given cryptographic key and/or a given encryption algorithm;
an order of the IEs within the set of one or more IEs before encryption thereof for the Container IE,
the padding portion 754 added to the set of one or more IEs before encryption thereof, and
optionally, removing one or more non-mandatory IEs from the set of one or more IEs before encryption. In other words, the station here voluntarily omits to send (or refrains from sending) one or more non-mandatory and/or non-critical IEs (for instance by re-scheduling their transmission in a future management frame when possible). Indeed, substantially changing the set of IEs helps to make the fingerprinting more difficult.

Hence during step 800, the station may transmit successive beacon frames that are identical or very similar (given few additions or removals of IEs).

At step 810, it is determined whether a new RCM procedure has to be performed in order to change the privacy parameters, e.g. MAC address or AID or BSSID, of the transmitting and/or receiving station. Such triggering event is out of scope of the present invention. This may be a periodic event or the result of more-complex policies.

In the affirmative of step 810, the privacy parameter or parameters are changed with new random values, at step 820.

Responsive to the changing step 820, the station modifies at step 830 the value of one or more of the above obfuscating features.

Indeed, a change of encryption key and/or encryption algorithm for a given Container IE substantially modifies the fingerprint of the Container IE, hence of the management frame. For example, a new encryption key can be derived from the current PTK or GTK. In a variant, the encryption key may be based on one privacy parameter of the station (e.g. PTK based on the MAC address of the concerned station, while GTK based on the MAC address of the AP station) so that a new privacy parameter (at step 820) automatically leads to a new encryption key. A new encryption algorithm may be selected randomly.

Similarly, a change of the order of the IEs within the Container IEs modifies the fingerprint. This may be a new random order, or a new order based on a round-robin or permutation or inversion or rotation basis.

Also, a varying padding (either in length or in content or both) substantially impacts the fingerprint of the corresponding Container IE, hence of the management frame. As an example, a new random padding length and/or content may be obtained and applied.

Once the new obfuscating features are set, they are applied at step 800.

The station may then keep going on transmitting successive beacon frames with the (quite) same IEs, but now with a very different fingerprint compared to the previous beacon frames before steps 820/830.

Enhanced used privacy is therefore obtained in particular regarding risks of fingerprinting by an observer.

FIG. 9 illustrates this advantageous situation based on the beacon frame transmissions of FIG. 2 enhanced with one or several embodiments of the invention.

In this figure, the beacon frames are obfuscated by encrypting a set of IEs in a Container IE 710.

In this example, an encrypted Container IE C-IE #1 contains the IEs IE #2 to IE #n of FIG. 2. As a result, the information transmitted by the beacon frames 911, 912 are the same, but some IEs are grouped and encrypted as a whole. The result is that it is not possible for an observer to determine the content of the beacon frame, except that there are two IEs (IE #1 and C-IE #1).

Upon a change 920 of privacy parameters of the mobile AP 110, the AP created a new encrypted Container IE C-IE #2 having the same IEs embedded, but using new obfuscating parameters (for example by changing the length and/or the value of the padding portion 754).

The observer still sees two IEs (IE #1 and C-IE #1). However, due to the substantial change in IE C-IE #2 compared to IE C-IE #1, it is no longer possible for the observer to correlate C-IE #1 and C-IE #2, hence to correlate beacon frames 911/912 and 930.

In other words, there is much less information available to correlate the beacon frame emitted before and after the change of privacy parameters.

Of course, some IEs may remain freely available for some stations that never registered to the AP, but that information may be restricted to the minimal required information and advantageously also be changed responsive to the change of privacy parameters at step 820.

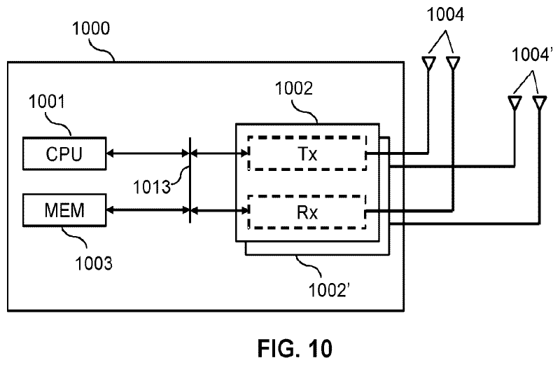

FIG. 10 schematically illustrates a communication device 1000, typically any of the stations of FIG. 1, of a wireless network, configured to implement at least one embodiment of the present invention. The communication device 1000 may preferably be a device such as a micro-computer, a workstation or a light portable device. The communication device 700 may comprise a communication bus 1013 to which may be connected:
a central processing unit 1001, such as a processor, denoted CPU;
a memory 1003, denoted MEM, for storing an executable code of methods or steps of the methods according to embodiments of the invention as well as the registers adapted to record variables and parameters necessary for implementing the methods; and
at least two communication interfaces 1002 and 1002′ connected to the wireless communication network, for example a communication network according to one of the IEEE 802.11 family of standards, via transmitting and receiving antennas 1004 and 1004′, respectively.

Preferably the communication bus 1013 may provide communication and interoperability between the various elements included in the communication device 1000 or connected to it. The representation of the bus is not limiting and in particular the central processing unit is operable to communicate instructions to any element of the communication device 1000 directly or by means of another element of the communication device 1000.

The executable code may be stored in a memory that may either be read only, a hard disk or on a removable digital medium such as for example a disk. According to an optional variant, the executable code of the programs can be received by means of the communication network, via the interface 1002 or 1002′, in order to be stored in the memory 1003 of the communication device 1000 before being executed.

In an embodiment, the device 1000 may be a programmable apparatus which uses software to implement embodiments of the invention. However, alternatively, embodiments of the present invention may be implemented, totally or in partially, in hardware (for example, in the form of an Application Specific Integrated Circuit or ASIC).

Embodiment(s) of the present invention can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), etc.), a flash memory device, a memory card, and the like.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the invention.

1. A communication method in a wireless network, comprising, at a station:
encrypting a set of one or more information elements, IEs, to be included in a management frame to be transmitted, into an encrypted portion,
embedding the encrypted portion within an information field of a container IE,
embedding the resulting container IE in a body of the management frame, and
transmitting the resulting management frame over the wireless network.

2. The method of claim 1, further comprising adding a padding portion to the set of one or more IEs before encrypting them together into the encrypted portion.

3. The method of claim 2, wherein a length and/or a binary content of the padding portion is variable between container IEs and/or over time.

4. The method of claim 1, further comprising calculating a hash of the encrypted portion and including the hash in a subfield preceding the encrypted portion within the information field of the container IE.

5. The method of claim 1, further comprising signaling an encryption scheme of the encrypted portion in a subfield preceding the encrypted portion within the information field of the container IE.

6. The method of claim 5, wherein the encryption scheme is signaled in a non-encrypted IE preceding the encrypted portion within the information field of the container IE.

7. The method of claim 1, further comprising signaling an encryption scheme of the encrypted portion in a non-encrypted IE preceding the container IE within the body of the management frame.

8. The method of claim 1, further comprising determining an encryption scheme for encrypting the set, based on a predefined table matching encryption schemes with respective IEs.

9. The method of claim 1, wherein plural container IEs containing encrypted portions corresponding to respective encrypted sets of one or more IEs are embedded in the body of the management frame.

10. The method of claim 1, wherein one IE included in the management frame that is transmitted is an isolated IE directly embedded within the body of the management frame, with an encrypted information field and non-encrypted type and length fields of the isolated IE.

11. The method of claim 10, wherein an encryption scheme of the encrypted information field is signaled in a separate non-encrypted IE preceding the isolated IE within the body of the management frame.

12. The method of claim 1, further comprising determining, for each IE to be included in the management frame, whether to aggregate the IE with other IEs in a container IE before encryption or to encrypt the IE as an isolated IE.

13. The method of claim 12, wherein the determining is based on one or more criteria selected from the following set of criteria:
whether the IE is used by a station addressee of the management frame to associate with a station transmitting the management frame,
whether the IE is mandatory or optional according to the IEEE802.11 standards family, and
a type of the management frame, and optionally on a type of the IE.

14. (canceled)

15. (canceled)

16. The method of claim 12, comprising, in case it is determined to aggregate the IE, determining an encryption scheme for the IE and selecting a container IE associated with the same encryption scheme as the determined encryption scheme.

17. The method of claim 12, wherein a single container IE associated with a given encryption scheme is embedded within the body of the management frame, to aggregate all the IEs of the management frame that are associated with the encryption scheme.

18. (canceled)

19. (canceled)

20. The method of claim 1, further comprising determining an encryption scheme for the set of one or more IEs,
wherein the encryption scheme includes an encryption key and an encryption algorithm, and
wherein the encryption key is a group temporal key, GTK, shared between an AP station managing a Basic Service Set and all non-AP stations of the BSS.

21. (canceled)

22. (canceled)

23. The method of claim 1, further comprising determining an encryption scheme for the set of one or more IEs, wherein the encryption scheme includes an encryption key and an encryption algorithm, and wherein the encryption key is a private transient key, PTK, shared between an AP station managing a Basic Service Set and a single non-AP station of the BSS.

24. (canceled)

25. The method of claim 1, further comprising changing a value of at least one privacy parameter of the station, and responsive to the changing step, modifying at least one obfuscating parameter used to obfuscate the set of one or more IEs within the container IE.

26. The method of claim 25, wherein the at least one obfuscating parameter includes one or more from:
an encryption scheme for encrypting the set of one or more IEs;
an order of the IEs within the set of one or more IEs before encryption thereof,
a padding portion added to the set of one or more IEs before encryption thereof, and
removing one or more non-mandatory IEs from the set of one or more IEs before encryption.

27. The method of claim 1, in an 802.11 wireless network, wherein the one or more IEs and the management frame are respectively 802.11 IEs and an 802.11 management frame, as defined in the IEEE802.11 standards family.

28. The method of claim 27, wherein the management frame is one from a beacon frame, an association request frame, an association response frame, a disassociation frame, a re-association request frame, a re-association response frame, a probe request frame, a probe response frame, an authentication frame, a de-authentication frame, an action frame.

29. A communication method in a wireless network, comprising, at a station:
receiving a management frame over the wireless network,
retrieving a container IE from a body of the received management frame, and
decoding an information field of the retrieved container IE to obtain a set of one or more IEs.

30. (canceled)

31. (canceled)

32. A wireless communication device comprising at least one microprocessor configured for carrying out the steps of the method of claim 1.

33. A non-transitory computer-readable medium storing a program which, when loaded into and executed by a microprocessor or computer system in a wireless device, causes the wireless device to perform the method of claim 1.

34-37. (canceled)
